(19) United States
(12) Patent Application Publication
(10) Pub. No.: US 2025/0206329 A1
(43) Pub. Date: Jun. 26, 2025

(54) DRIVING ASSISTANCE APPARATUS, SYSTEM, NON-TRANSITORY COMPUTER READABLE MEDIUM, AND DRIVING ASSISTANCE METHOD

(71) Applicant: TOYOTA JIDOSHA KABUSHIKI KAISHA, Toyota-shi (JP)

(72) Inventors: Toshiki KASHIWAKURA, Ota-ku (JP); Chihiro INABA, Nerima-ku (JP); Shoi SUZUKI, Ota-ku (JP); Tsuyoshi OKADA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/001,638

(22) Filed: Dec. 26, 2024

(30) Foreign Application Priority Data
Dec. 26, 2023 (JP) 2023-219905

(51) Int. Cl. B60W 50/14; B60W 60/00

(52) U.S. Cl. CPC B60W 50/14; B60W 60/001; B60W 2050/146; B60W 2420/403; B60W 2556/45; B60W 2756/10

(57) ABSTRACT

A driving assistance apparatus includes a controller that is configured to acquire video obtained by imaging, with a camera, a sidewalk along which a pedestrian passes, the sidewalk bordering on a roadway on which an automated driving vehicle travels, and upon detecting the pedestrian in the acquired video, cause a terminal apparatus of an operator of the automated driving vehicle to output a notification that the video is available for display.

### CROSS-REFERENCE TO RELATED APPLICATION

This application claims priority to Japanese Patent Application No. 2023-219905, filed on Dec. 26, 2023, the entire contents of which are incorporated herein by reference.

### TECHNICAL FIELD

The present disclosure relates to a driving assistance apparatus, a system, a program, and a driving assistance method.

### BACKGROUND

Patent Literature (PTL) 1 discloses a notification system that recognizes the behavior of an automated driving vehicle scheduled to pass through a predetermined traffic area, and notifies pedestrians or vehicles other than the automated driving vehicle of whether the pedestrians or other vehicles can pass through, a warning, and the like.

### CITATION LIST

### Patent Literature

PTL 1: JP 2023-050629 A

### SUMMARY

Operators in vehicles or at remote locations may assist in the operation of the automated driving vehicles. In conventional technology, however, videos of pedestrians are not presented to the operators. Therefore, the safety in the operation of the automated driving vehicles is not sufficient.

It would be helpful to improve safety in the operation of automated driving vehicles.

A driving assistance apparatus according to the present disclosure includes a controller configured to:
acquire video obtained by imaging, with a camera, a sidewalk along which a pedestrian passes, the sidewalk bordering on a roadway on which an automated driving vehicle travels; and
upon detecting the pedestrian in the acquired video, cause a terminal apparatus of an operator of the automated driving vehicle to output a notification that the video is available for display.

A program according to the present disclosure is configured to cause a computer to execute operations, the operations including:
outputting a notification that video is available for display, the video being obtained by imaging, with a camera, a sidewalk along which a pedestrian passes, the sidewalk bordering on a roadway on which an automated driving vehicle travels; and
displaying the video in response to an operation, by an operator of the automated driving vehicle, to instruct display of the video.

A driving assistance method according to the present disclosure includes:
acquiring, by a driving assistance apparatus, video obtained by imaging, with a camera, a sidewalk along which a pedestrian passes, the sidewalk bordering on a roadway on which an automated driving vehicle travels; and
upon detecting the pedestrian in the acquired video, causing, by the driving assistance apparatus, a terminal apparatus of an operator of the automated driving vehicle to output a notification that the video is available for display.

According to the present disclosure, safety in the operation of automated driving vehicles is improved.

### BRIEF DESCRIPTION OF THE DRAWINGS

In the accompanying drawings:

FIG. 1 is a diagram illustrating a configuration of a system according to first and second embodiments of the present disclosure;

FIG. 2 is a diagram illustrating an example of the use of the system according to the first and second embodiments of the present disclosure;

FIG. 3 is a block diagram illustrating a configuration of a driving assistance apparatus according to the first and second embodiments of the present disclosure;

FIG. 4 is a block diagram illustrating a configuration of a terminal apparatus according to the first and second embodiments of the present disclosure;

FIG. 5 is a flowchart illustrating operations of the driving assistance apparatus according to the first embodiment of the present disclosure;

FIG. 6 is a flowchart illustrating operations of the terminal apparatus according to the first embodiment of the present disclosure;

FIG. 7 is a flowchart illustrating operations of the driving assistance apparatus according to the second embodiment of the present disclosure; and

FIG. 8 is a flowchart illustrating operations of the terminal apparatus according to the second embodiment of the present disclosure.

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment, which is an embodiment of the present disclosure, will be described.

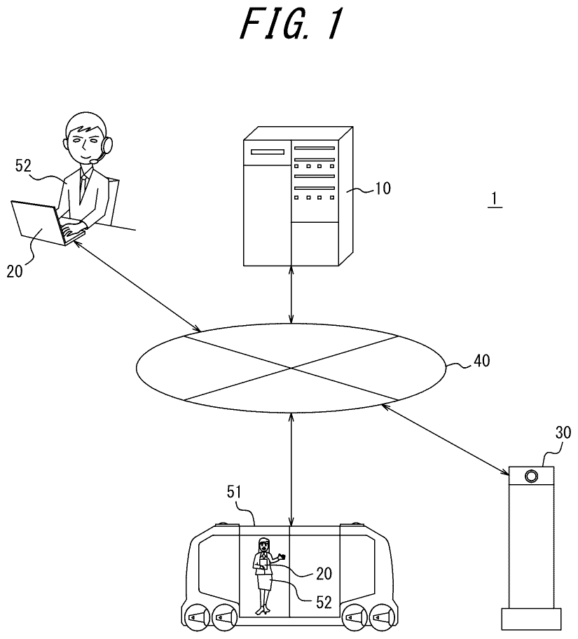

A configuration of a system 1 according to the present embodiment will be described with reference to FIG. 1.

The system 1 according to the present embodiment includes a driving assistance apparatus 10, a terminal apparatus 20, and a camera 30. The driving assistance apparatus 10 can communicate with the terminal apparatus 20 via a network 40. The driving assistance apparatus 10 can communicate with the camera 30 via the network 40.

The driving assistance apparatus 10 is installed in a facility such as a data center. The driving assistance apparatus 10 is a computer such as a server that belongs to a cloud computing system or another type of computing system.

The terminal apparatus 20 is used by an operator 52 who assists in the operation of an automated driving vehicle 51. The operator 52 may be in the vehicle 51 or in an external facility such as an operation control room. When the operator 52 is in the vehicle 51, the terminal apparatus 20 is held by the operator 52. When the operator 52 is in the external facility, the terminal apparatus 20 is installed in the external facility. The terminal apparatus 20 is, for example, a mobile device such as a mobile phone, a smartphone, or a tablet, or a PC. The term “PC” is an abbreviation of personal computer.

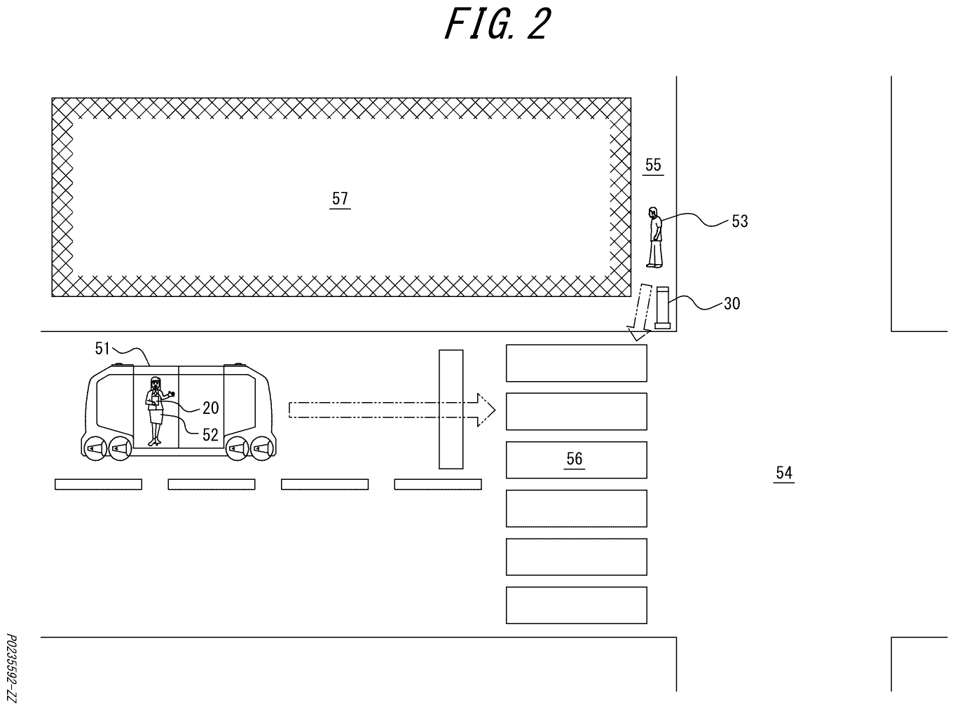

As illustrated in FIG. 2, the camera 30 is installed in a location so as to be able to image a sidewalk 55, which borders on a roadway 54 on which the automated driving vehicle 51 travels, and along which a pedestrian 53 passes. In the example illustrated in FIG. 2, the location in which the camera 30 is installed is in the vicinity of a blind spot from the roadway 54, but the camera 30 may be installed directly in the blind spot. In the example illustrated in FIG. 2, the location in which the camera 30 is installed is in the vicinity of a crosswalk 56 on the roadway 54, but the camera 30 may be installed directly on the crosswalk 56. In the example illustrated in FIG. 2, when a vehicle is traveling from the left to the right on the roadway 54, a portion of the sidewalk 55 blocked by a building 57 is the blind spot from the roadway 54 until that vehicle passes through the crosswalk 56. The camera 30 is supported by a long column, such as a cylindrical column, so as to be located at a desired height. In addition to the camera 30, the column may be equipped with a light such as LEDs, a speaker, or a display, to notify the pedestrian 53 of an approach of the automated driving vehicle 51. The term “LED” is an abbreviation of light-emitting diode.

The automated driving vehicle 51 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The automated driving vehicle 51 is an AV in the present embodiment, and the driving is automated at a high level. The term “AV” is an abbreviation of autonomous vehicle. The automation level is, for example, Level 3 or Level 4 according to the level classification defined by SAE. The name “SAE” is an abbreviation of Society of Automotive Engineers.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIGS. 1 and 2.

In the present embodiment, the driving assistance apparatus 10 acquires video VD obtained by imaging the sidewalk 55 with the camera 30. Upon detecting a pedestrian 53 in the acquired video VD, the driving assistance apparatus 10 causes the terminal apparatus 20 of the operator 52 of the automated driving vehicle 51 to output a notification ND that the video VD is available for display. The pedestrian 53 is not limited to a person, but also include a wheelchair or other mobile objects that can pass along the sidewalk 55. The terminal apparatus 20 outputs the notification ND. The terminal apparatus 20 displays the video VD in response to an operation by the operator 52 of the automated driving vehicle 51 to instruct display of the video VD.

According to the present embodiment, the video VD of the pedestrian 53 can be presented to the operator 52 of the automated driving vehicle 51 at the request of the operator 52. Thus, safety in the operation of the automated driving vehicle 51 is improved.

In the example illustrated in FIG. 2, the operator 52 is on board the automated driving vehicle 51. The operator 52 operates the terminal apparatus 20, and checks the notification ND from the terminal apparatus 20. The pedestrian 53 is passing along the sidewalk 55 and is about to cross the crosswalk 56 on the roadway 54. The pedestrian 53 is behind the building 57, which blocks the sidewalk 55, with respect to a direction of travel of the automated driving vehicle 51, making it difficult for the operator 52 to see the pedestrian 53. The camera 30 is thus installed in the vicinity of the blind spot from the roadway 54, which is not visible from the operator 52. The camera 30 is imaging the sidewalk 55 with its back facing the roadway 54. The camera 30 can transmit the video VD, which is obtained by imaging the sidewalk 55, to the driving assistance apparatus 10 via the network 40.

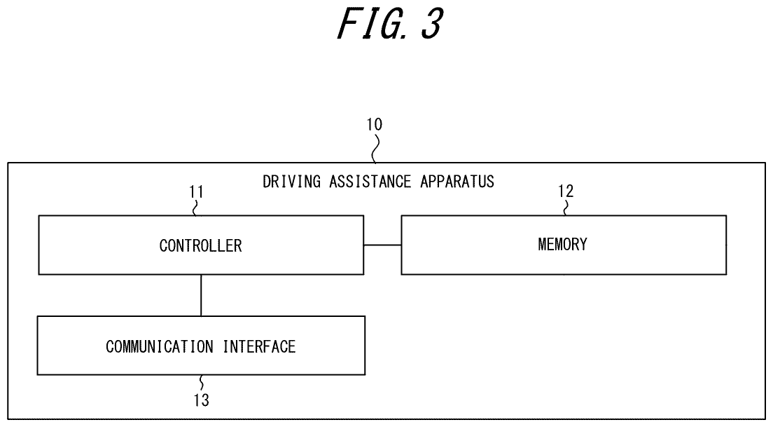

A configuration of the driving assistance apparatus 10 according to the present embodiment will be described with reference to FIG. 3.

The driving assistance apparatus 10 includes a controller 11, a memory 12, and a communication interface 13.

The controller 11 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 11 executes processes related to operations of the driving assistance apparatus 10 while controlling components of the driving assistance apparatus 10.

The memory 12 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 12 functions as, for example, a main memory, an auxiliary memory, or a cache memory. The memory 12 stores data to be used for the operations of the driving assistance apparatus 10 and data obtained by the operations of the driving assistance apparatus 10.

The communication interface 13 includes at least one interface for communication. The interface for communication is, for example, a LAN interface. The communication interface 13 receives data to be used for the operations of the driving assistance apparatus 10, and transmits data obtained by the operations of the driving assistance apparatus 10.

The functions of the driving assistance apparatus 10 are realized by execution of a control program according to the present embodiment by a processor serving as the controller 11. That is, the functions of the driving assistance apparatus 10 are realized by software. The control program causes a computer to execute the operations of the driving assistance apparatus 10, thereby causing the computer to function as the driving assistance apparatus 10. That is, the computer executes the operations of the driving assistance apparatus 10 in accordance with the control program to thereby function as the driving assistance apparatus 10.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the driving assistance apparatus 10 may be realized by a programmable circuit or a dedicated circuit serving as the controller 11. That is, some or all of the functions of the driving assistance apparatus 10 may be realized by hardware.

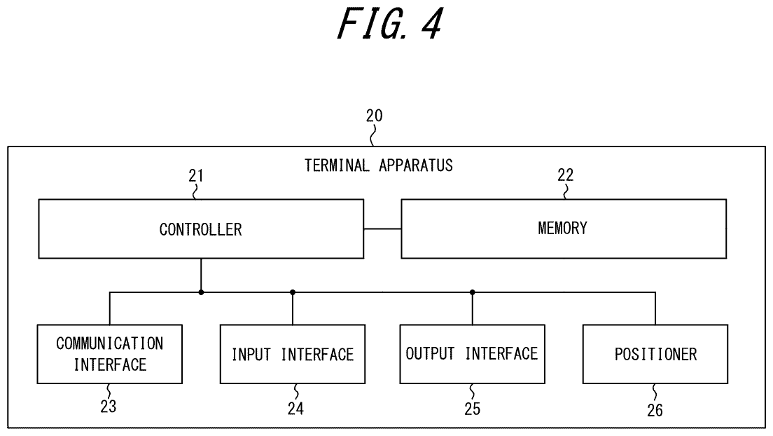

A configuration of the terminal apparatus 20 according to the present embodiment will be described with reference to FIG. 4.

The terminal apparatus 20 includes a controller 21, a memory 22, a communication interface 23, an input interface 24, an output interface 25, and a positioner 26.

The controller 21 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 21 executes processes related to operations of the terminal apparatus 20 while controlling components of the terminal apparatus 20.

The memory 22 includes at least one semiconductor memory, at least one magnetic memory, at least one optical memory, or any combination thereof. The semiconductor memory is, for example, RAM or ROM. The RAM is, for example, SRAM or DRAM. The ROM is, for example, EEPROM. The memory 22 functions as, for example, a main memory, an auxiliary memory, or a cache memory. The memory 22 stores data to be used for the operations of the terminal apparatus 20 and data obtained by the operations of the terminal apparatus 20.

The communication interface 23 includes at least one interface for communication. The interface for communication is, for example, an interface compliant with a mobile communication standard such as LTE, 4G standard, or 5G standard, or a LAN interface. The term “LTE” is an abbreviation of Long Term Evolution. The term “4G” is an abbreviation of 4th generation. The term “5G” is an abbreviation of 5th generation. The communication interface 23 receives data to be used for the operations of the terminal apparatus 20, and transmits data obtained by the operations of the terminal apparatus 20.

The input interface 24 includes at least one interface for input. The interface for input is, for example, a physical key, a capacitive key, a pointing device, a touch screen integrally provided with a display, a camera, or a microphone. The input interface 24 accepts an operation for inputting data to be used for the operations of the terminal apparatus 20. The input interface 24 may be connected to the terminal apparatus 20 as an external input device, instead of being included in the terminal apparatus 20. As an interface for connection, for example, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the terminal apparatus 20. The output interface 25 may be connected to the terminal apparatus 20 as an external output device, instead of being included in the terminal apparatus 20. As an interface for connection, for example, an interface compliant with a standard such as USB, HDMI®, or Bluetooth® can be used.

The positioner 26 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 26 measures the position of the terminal apparatus 20.

The functions of the terminal apparatus 20 are realized by execution of a terminal program according to the present embodiment by a processor serving as the controller 21. That is, the functions of the terminal apparatus 20 are realized by software. The terminal program causes a computer to execute the operations of the terminal apparatus 20, thereby causing the computer to function as the terminal apparatus 20. That is, the computer executes the operations of the terminal apparatus 20 in accordance with the terminal program to thereby function as the terminal apparatus 20.

Some or all of the functions of the terminal apparatus 20 may be realized by a programmable circuit or a dedicated circuit serving as the controller 21. That is, some or all of the functions of the terminal apparatus 20 may be realized by hardware.

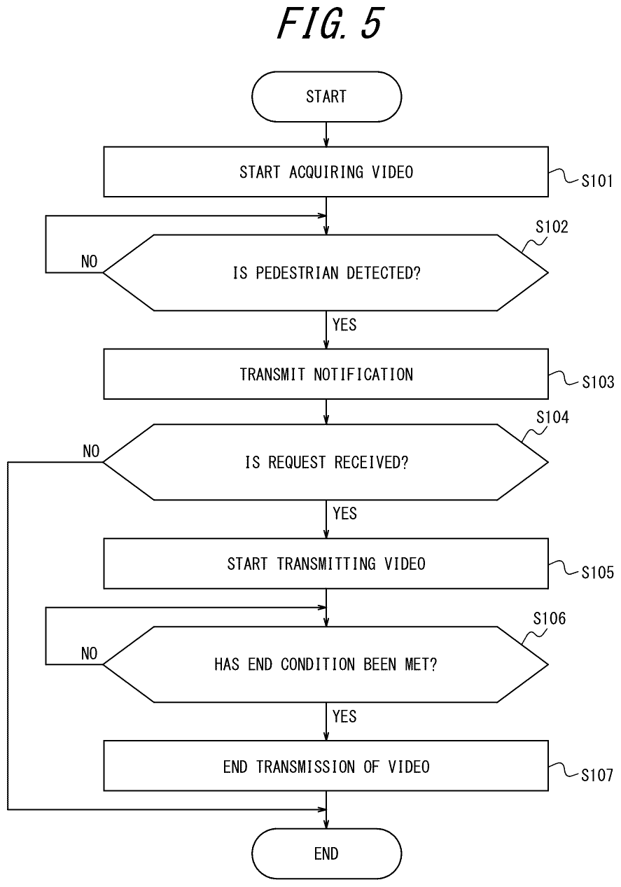

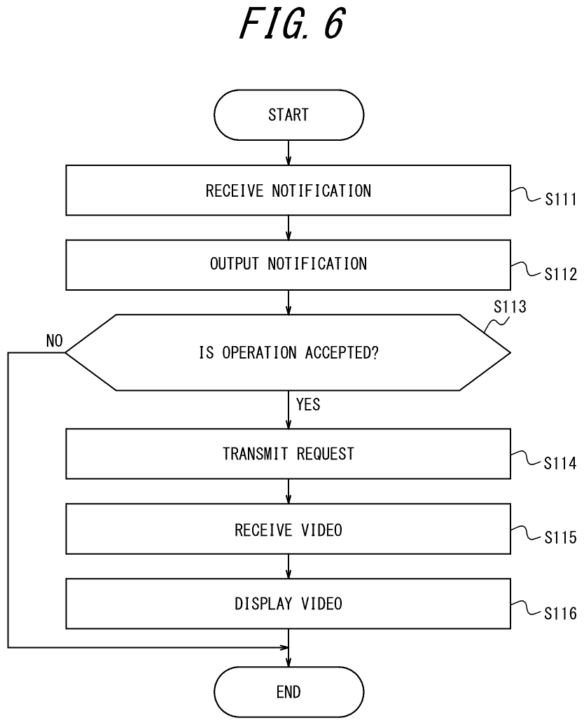

Operations of the system 1 according to the present embodiment will be described with reference to FIGS. 5 and 6. These operations correspond to a driving assistance method according to the present embodiment. FIG. 5 illustrates operations of the driving assistance apparatus 10. FIG. 6 illustrates operations of the terminal apparatus 20.

In S101 of FIG. 5, the controller 11 of the driving assistance apparatus 10 acquires video VD. Specifically, the controller 11 receives the video VD from the camera 30 via the communication interface 13. The controller 11 continues receiving the video VD while the automated driving vehicle 51 is traveling on the roadway 54, at least until the automated driving vehicle 51 passes by the location in which the camera 30 is installed.

In S102 of FIG. 5, the controller 11 of the driving assistance apparatus 10 detects a pedestrian 53 in the video VD acquired in S101. Specifically, the controller 11 recognizes, as a mobile object, an object whose position varies between frames of the video VD acquired in S101. Any method can be used to recognize the object in the frames. The controller 11 determines that the larger the rectangular area when the recognized mobile object is surrounded by a rectangle, the closer the mobile object is to the camera 30, and the smaller the rectangular area, the further the mobile object is from the camera 30. When the rectangular area becomes larger with a lapse of time, the controller 11 determines that the mobile object is approaching the camera 30. When the rectangular area becomes smaller with a lapse of time, the controller 11 determines that the mobile object is moving away from the camera 30. The controller 11 detects the mobile object, as the pedestrian 53, when the rectangular area is equal to or more than a predetermined size and is getting larger with a lapse of time. The predetermined size is, for example, 10% of a frame size. The controller 11 may not detect the mobile object, as the pedestrian 53, when the rectangular area is less than the predetermined size or is getting smaller with a lapse of time. Upon detecting the pedestrian 53, the controller 11 proceeds to the process of S103. The controller 11 repeats the process of recognizing a mobile object in sequentially acquired frames of the video VD, until the pedestrian 53 is detected.

In S103 of FIG. 5, the controller 11 of the driving assistance apparatus 10 transmits, via the communication interface 13 to the terminal apparatus 20, a notification NS that the video VD is available for transmission. At this time, the controller 11 identifies the terminal apparatus 20, as a terminal apparatus to which the notification NS is to be transmitted. Any method can be adopted as a method of identifying the terminal apparatus to which the notification NS is to be transmitted. As an example, the controller 11 receives, via the communication interface 13, positional data indicating the position of the terminal apparatus 20. The controller 11 calculates the distance between the position indicated by the received positional data and the location in which the camera 30 is installed. When the calculated distance is within a predetermined distance range and the calculated distance becomes shorter, the controller 11 identifies the terminal apparatus 20, as the terminal apparatus to which the notification NS is to be transmitted. When the calculated distance is more than the predetermined distance range or the calculated distance becomes longer, the controller 11 does not identify the terminal apparatus 20, as the terminal apparatus to which the notification NS is to be transmitted. The predetermined distance is, for example, 100 meters.

In S111 of FIG. 6, the controller 21 of the terminal apparatus 20 receives the notification NS from the driving assistance apparatus 10. Specifically, the controller 21 receives, via the communication interface 23, the notification NS transmitted from the driving assistance apparatus 10 in S103.

In S112 of FIG. 6, upon receiving the notification NS from the driving assistance apparatus 10 in S111, the controller 21 of the terminal apparatus 20 outputs a notification ND that the video VD is available for display. Specifically, the controller 11 displays the notification ND on a screen of a display as the output interface 25. The notification ND includes a graphic element for accepting an operation by the operator 52 to instruct display of the video VD. The graphic element is, for example, a button, such as a “video” button, or an icon indicating a pedestrian. The controller 11 may output the notification ND by audio from a speaker as the output interface 25.

In S113 of FIG. 6, the controller 21 of the terminal apparatus 20 accepts, via the input interface 24, the operation by the operator 52 to instruct display of the video VD. The operation is, for example, a tap on the graphic element. When the operator 52 taps the graphic element, i.e., when the controller 21 accepts the operation, the controller 21 proceeds to the process of S114. When the operator 52 does not tap the graphic element, i.e., the controller 21 does not accept the operation, the operations of the terminal apparatus 20 end.

In S114 of FIG. 6, the controller 21 of the terminal apparatus 20 transmits a request to the driving assistance apparatus 10. Specifically, the controller 21 transmits, via the communication interface 23 to the driving assistance apparatus 10, a notification that display of the video VD is instructed, as the request.

In S104 of FIG. 5, the controller 11 of the driving assistance apparatus 10 receives the request from the terminal apparatus 20. Specifically, the controller 11 receives, via the communication interface 13, the request transmitted from the terminal apparatus 20 in S114. Upon receiving the request, the controller 11 proceeds to the process of S105. When the controller 11 does not receive the request, the operations of the driving assistance apparatus 10 end.

In S105 of FIG. 5, the controller 11 of the driving assistance apparatus 10 starts transmitting the video VD via the communication interface 13 to the terminal apparatus 20, in response to the request received in S104. Specifically, the controller 11 transmits the video VD in streaming format. The controller 11 continues transmitting the video VD via the communication interface 13 to the terminal apparatus 20 until S107, which is described below.

In S115 of FIG. 6, the controller 21 of the terminal apparatus 20 receives, via the communication interface 23, the video VD transmitted from the driving assistance apparatus 10 in S105.

In S116 of FIG. 6, the controller 21 of the terminal apparatus 20 displays the video VD received in S115. Specifically, the controller 21 displays the video VD received in S115, on the screen of the display as the output interface 25. By looking at the video VD, the operator 52 can check the pedestrian 53 approaching the roadway 54 and the crosswalk 56.

In S106 of FIG. 5, the controller 11 of the driving assistance apparatus 10 determines whether an end condition has been met. The end condition includes the condition that the automated driving vehicle 51 has passed the location at which the camera 30 is installed. Any method can be adopted as a method of determining the end condition. As an example, the controller 11 receives, via the communication interface 13, the positional data indicating the position of the terminal apparatus 20. The controller 11 calculates the distance between the position indicated by the received positional data and the location in which the camera 30 is installed. When the calculated distance increases, the controller 11 determines that the automated driving vehicle 51 has passed by the location in which the camera 30 is installed and the end condition has been met. When the calculated distance decreases, the controller 11 determines that the automated driving vehicle 51 has not yet passed by the location and the end condition has not been met. When it is determined that the end condition has been met, the controller 11 proceeds to the process of S107. The controller 11 repeats the process of S106 until the end condition is met.

In S107 of FIG. 5, the controller 11 of the driving assistance apparatus 10 ends the transmission of the video VD. This terminates the display of the video VD on the terminal apparatus 20.

After transmitting the notification NS in S103, the controller 11 of the driving assistance apparatus 10 may perform a process of determining whether the same end condition as in S106 has been met, while waiting until the request from the terminal apparatus 20 is received in S104. Upon determining in S104 that the end condition has been met, the controller 11 ends the wait for receipt of the request. The controller 11 does not transmit the video VD even when the request is received after determining in S104 that the end condition has been met. In the example of FIG. 2, the controller 11 ends the wait for receipt of the request when it is determined that the automated driving vehicle 51 has passed through the crosswalk 56 and in S104 that the end condition has been met. The controller 11 does not transmit the video VD even when the request is received after it is determined that the automated driving vehicle 51 has passed through the crosswalk 56 and in S104 that the end condition has been met.

As described above, in the present embodiment, the controller 11 of the driving assistance apparatus 10 acquires video VD that is obtained by imaging the sidewalk 55 with the camera 30. Upon detecting a pedestrian 53 in the acquired video VD, the controller 11 of the driving assistance apparatus 10 causes the terminal apparatus 20 to output a notification ND that the video VD is available for display, by transmitting, via the communication interface 13 to the terminal apparatus 20, a notification NS that the video VD is available for transmission. Upon receiving the notification NS via the communication interface 23, the controller 21 of the terminal apparatus 20 outputs the notification ND. The controller 21 of the terminal apparatus 20 requests transmission of the video VD to the driving assistance apparatus 10, in response to an operation, by the operator 52 of the automated driving vehicle 51, to instruct display of the video VD. Upon receiving the video VD via the communication interface 23, the controller 21 of the terminal apparatus 20 displays the video VD.

In a tense situation in which the automated driving vehicle 51 is traveling by a point with a blind spot, the operator 52 may not have time to look at the screen of the terminal apparatus 20. According to the present embodiment, instead of the video VD being presented by default before passing by such a point, only the notification ND is output, allowing the operator 52 to check the video VD with the own intent of the operator 52. This increases safety in the operation of the automated driving vehicle 51. However, when the operator 52 is in the external facility, it is more likely that the operator 52 has more time to look at the screen of the terminal apparatus 20 than when the operator 52 is in the vehicle 51. Therefore, when the operator 52 is in the external facility, the video VD may be presented by default.

As a variation of the present embodiment, the controller 11 of the driving assistance apparatus 10 may transmit the video VD, regardless of the presence or absence of the request from the terminal apparatus 20. A second embodiment, such a variation, will be described.

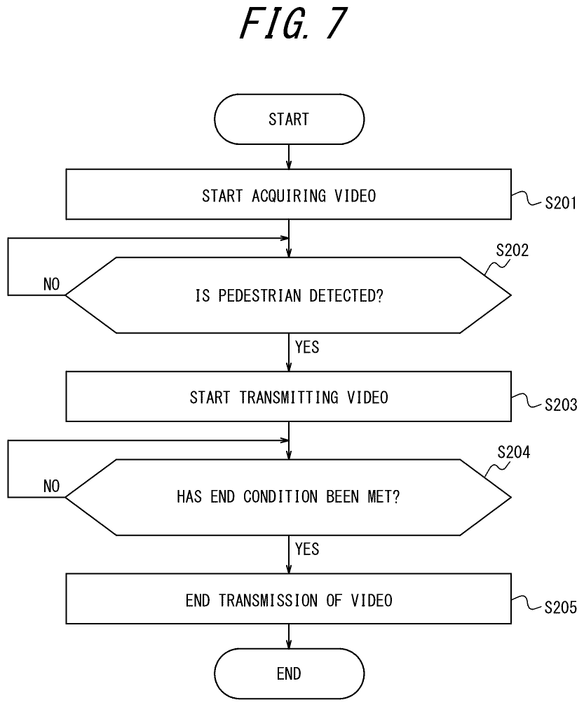

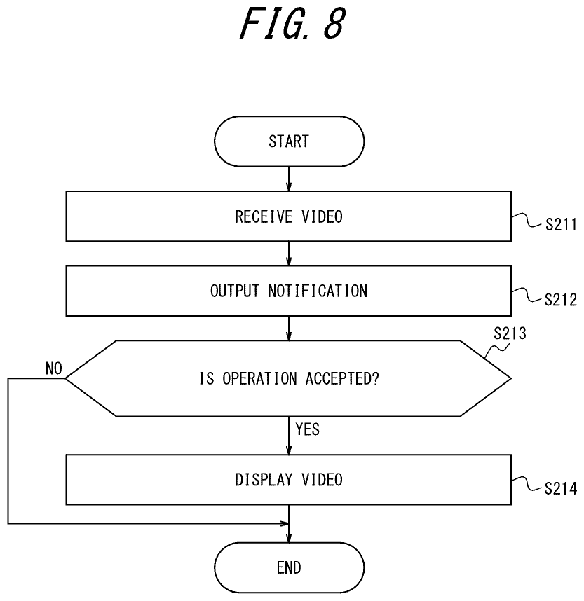

Operations of the system 1 according to the present embodiment will be described with reference to FIGS. 7 and 8. These operations correspond to a driving assistance method according to the present embodiment. FIG. 7 illustrates operations of the driving assistance apparatus 10. FIG. 8 illustrates operations of the terminal apparatus 20.

The processes in S201 and S202 of FIG. 7 are the same as those in S101 and S102 of FIG. 5, respectively, and thus descriptions thereof are omitted.

In S203 of FIG. 7, upon detecting, in S202, a pedestrian 53 in video VD, the controller 11 of the driving assistance apparatus 10 starts transmitting the video VD via the communication interface 13 to the terminal apparatus 20. At this time, the controller 11 identifies the terminal apparatus 20, as a terminal apparatus to which the video VD is to be transmitted. Any method can be adopted as a method of identifying the terminal apparatus to which the video VD is to be transmitted. As an example, the controller 11 receives, via the communication interface 13, positional data indicating the position of the terminal apparatus 20. The controller 11 calculates the distance between the position indicated by the received positional data and the location in which the camera 30 is installed. When the calculated distance is within a predetermined distance range and the calculated distance becomes shorter, the controller 11 identifies the terminal apparatus 20, as the terminal apparatus to which the video VD is to be transmitted. When the calculated distance is more than the predetermined distance range or the calculated distance becomes longer, the controller 11 does not identify the terminal apparatus 20, as the terminal apparatus to which the video VD is to be transmitted. The predetermined distance is, for example, 100 meters. The controller 11 continues transmitting the video VD via the communication interface 13 to the terminal apparatus 20 until S205, which is described below, regardless of the presence or absence of a request from the terminal apparatus 20.

The process in S211 of FIG. 8 is the same as that in S115 of FIG. 6, and thus a description thereof is omitted.

In S212 of FIG. 8, upon starting to receive the video VD from the driving assistance apparatus 10 in S211, the controller 21 of the terminal apparatus 20 outputs a notification ND that the video VD is available for display. An output and display example of the notification ND is the same as that in S112 in the first embodiment, and thus a description thereof is omitted.

The process in S213 of FIG. 8 is the same as that in S113 of FIG. 6, and thus a description thereof is omitted.

Upon accepting an operation by the operator 52 in S213, the controller 21 of the terminal apparatus 20 starts displaying the video VD in S214 of FIG. 8. A display example of the video VD is the same as that in S116 in the first embodiment, and thus a description thereof is omitted.

The processes in S204 and S205 of FIG. 7 are the same as those in S106 and S107 of FIG. 5, respectively, and thus descriptions thereof are omitted.

As described above, in the present embodiment, the controller 11 of the driving assistance apparatus 10 acquires video VD that is obtained by imaging the sidewalk 55 with the camera 30. Upon detecting a pedestrian 53 in the acquired video VD, the controller 11 of the driving assistance apparatus 10 causes the terminal apparatus 20 to output a notification ND that the video VD is available for display, by transmitting the video VD via the communication interface 13 to the terminal apparatus 20. Upon receiving the video VD via the communication interface 23, the controller 21 of the terminal apparatus 20 outputs the notification ND. The controller 21 of the terminal apparatus 20 starts displaying the video VD in response to an operation, by the operator 52 of the automated driving vehicle 51, to instruct display of the video VD.

According to the present embodiment, as in the first embodiment, instead of the video VD being presented by default before passing by a point with a blind spot, only the notification ND is output, allowing the operator 52 to check the video VD with the own intent of the operator 52. This increases safety in the operation of the automated driving vehicle 51. Moreover, in the present embodiment, since the terminal apparatus 20 continues receiving the video VD even while the terminal apparatus 20 is not displaying the video VD, it is possible to instantly respond to the instruction when display of the video VD is instructed by the operator 52.

The present disclosure is not limited to the embodiments described above. For example, two or more blocks described in the block diagram may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.

[Appendix 1] A driving assistance apparatus comprising a controller configured to:
acquire video obtained by imaging, with a camera, a sidewalk along which a pedestrian passes, the sidewalk bordering on a roadway on which an automated driving vehicle travels; and
upon detecting the pedestrian in the acquired video, cause a terminal apparatus of an operator of the automated driving vehicle to output a notification that the video is available for display.

[Appendix 2] The driving assistance apparatus according to appendix 1, further comprising a communication interface configured to communicate with the terminal apparatus,
wherein
the terminal apparatus is configured to transmit a request to the driving assistance apparatus upon accepting an operation by the operator to instruct display of the video, and
the controller is configured to transmit the video, in response to the request, via the communication interface to the terminal apparatus.

[Appendix 3] The driving assistance apparatus according to appendix 2, wherein
the terminal apparatus is configured to output the notification that the video is available for display upon receiving, from the driving assistance apparatus, a notification that the video is available for transmission, and
the controller is configured to transmit, via the communication interface to the terminal apparatus, the notification that the video is available for transmission upon detecting the pedestrian in the video.

[Appendix 4] The driving assistance apparatus according to appendix 1, further comprising a communication interface configured to communicate with the terminal apparatus,
wherein
the terminal apparatus is configured to start displaying the video upon accepting an operation by the operator to instruct display of the video, and
the controller is configured to continue transmitting the video via the communication interface to the terminal apparatus, regardless of presence or absence of a request from the terminal apparatus.

[Appendix 5] The driving assistance apparatus according to appendix 4, wherein
the terminal apparatus is configured to output the notification that the video is available for display upon starting to receive the video from the driving assistance apparatus, and
the controller is configured to start transmitting the video via the communication interface to the terminal apparatus, upon detecting the pedestrian in the video.

[Appendix 6] The driving assistance apparatus according to any one of appendices 1 to 5, further comprising a communication interface configured to communicate with the terminal apparatus,
wherein the controller is configured to:
   transmit the video via the communication interface to the terminal apparatus, in response to a request from the terminal apparatus or regardless of presence or absence of a request from the terminal apparatus; and
   end transmission of the video when an end condition is met.

[Appendix 7] The driving assistance apparatus according to appendix 6, wherein the end condition includes a condition that the automated driving vehicle has passed by a location in which the camera is installed.

[Appendix 8] The driving assistance apparatus according to appendix 7, wherein the location is a blind spot from the roadway or in a vicinity of the blind spot.

[Appendix 9] The driving assistance apparatus according to appendix 7, wherein the location is a crosswalk on the roadway or in a vicinity of the crosswalk.

[Appendix 10] A system comprising:
the driving assistance apparatus according to any one of appendices 1 to 9; and
a terminal apparatus.

[Appendix 11] A program configured to cause a computer to execute operations, the operations comprising:
outputting a notification that video is available for display, the video being obtained by imaging, with a camera, a sidewalk along which a pedestrian passes, the sidewalk bordering on a roadway on which an automated driving vehicle travels; and
displaying the video in response to an operation, by an operator of the automated driving vehicle, to instruct display of the video.

[Appendix 12] The program according to appendix 11, wherein the displaying includes:
transmitting a request to a driving assistance apparatus upon accepting the operation;
receiving the video from the driving assistance apparatus; and displaying the received video.

[Appendix 13] The program according to appendix 11, wherein
the operations further comprise receiving the video from the driving assistance apparatus, and
the displaying includes starting to display the received video upon accepting the operation.

[Appendix 14] The program according to any one of appendices 11 to 13, wherein the notification includes a graphic element to accept the operation.

[Appendix 15] The program according to appendix 14, wherein the operation is a tap on the graphic element.

[Appendix 16] The program according to appendix 14 or 15, wherein the graphic element is a button.

[Appendix 17] The program according to appendix 14 or 15, wherein the graphic element is an icon indicating the pedestrian.

[Appendix 18] A driving assistance method comprising:
acquiring, by a driving assistance apparatus, video obtained by imaging, with a camera, a sidewalk along which a pedestrian passes, the sidewalk bordering on a roadway on which an automated driving vehicle travels; and
upon detecting the pedestrian in the acquired video, causing, by the driving assistance apparatus, a terminal apparatus of an operator of the automated driving vehicle to output a notification that the video is available for display.

[Appendix 19] The driving assistance method according to appendix 18, wherein
the terminal apparatus is configured to transmit a request to the driving assistance apparatus upon accepting an operation by the operator to instruct display of the video, and
the driving assistance method further comprises transmitting, by the driving assistance apparatus, the video to the terminal apparatus in response to the request.

[Appendix 20] The driving assistance method according to appendix 18, wherein
the terminal apparatus is configured to start displaying the video upon accepting an operation by the operator to instruct display of the video, and
the driving assistance method further comprises continuing, by the driving assistance apparatus, transmitting the video to the terminal apparatus, regardless of presence or absence of a request from the terminal apparatus.

1. A driving assistance apparatus comprising a controller configured to:
acquire video obtained by imaging, with a camera, a sidewalk along which a pedestrian passes, the sidewalk bordering on a roadway on which an automated driving vehicle travels; and
upon detecting the pedestrian in the acquired video, cause a terminal apparatus of an operator of the automated driving vehicle to output a notification that the video is available for display.

2. The driving assistance apparatus according to claim 1, further comprising a communication interface configured to communicate with the terminal apparatus,
wherein
the terminal apparatus is configured to transmit a request to the driving assistance apparatus upon accepting an operation by the operator to instruct display of the video, and
the controller is configured to transmit, in response to the request, the video via the communication interface to the terminal apparatus.

3. The driving assistance apparatus according to claim 2, wherein
the terminal apparatus is configured to output the notification that the video is available for display upon receiving, from the driving assistance apparatus, a notification that the video is available for transmission, and
the controller is configured to transmit, via the communication interface to the terminal apparatus, the notification that the video is available for transmission upon detecting the pedestrian in the video.

4. The driving assistance apparatus according to claim 1, further comprising a communication interface configured to communicate with the terminal apparatus,
wherein
the terminal apparatus is configured to start displaying the video upon accepting an operation by the operator to instruct display of the video, and
the controller is configured to continue transmitting the video via the communication interface to the terminal apparatus, regardless of presence or absence of a request from the terminal apparatus.

5. The driving assistance apparatus according to claim 4, wherein
the terminal apparatus is configured to output the notification that the video is available for display upon starting to receive the video from the driving assistance apparatus, and
the controller is configured to start transmitting the video via the communication interface to the terminal apparatus, upon detecting the pedestrian in the video.

6. The driving assistance apparatus according to claim 1, further comprising a communication interface configured to communicate with the terminal apparatus,
wherein the controller is configured to:
transmit the video via the communication interface to the terminal apparatus, in response to a request from the terminal apparatus or regardless of presence or absence of a request from the terminal apparatus; and
end transmission of the video when an end condition is met.

7. The driving assistance apparatus according to claim 6, wherein the end condition includes a condition that the automated driving vehicle has passed by a location in which the camera is installed.

8. The driving assistance apparatus according to claim 7, wherein the location is a blind spot from the roadway or in a vicinity of the blind spot.

9. The driving assistance apparatus according to claim 7, wherein the location is a crosswalk on the roadway or in a vicinity of the crosswalk.

10. A system comprising:
the driving assistance apparatus according to claim 1; and
a terminal apparatus.

11. A non-transitory computer readable medium storing a program configured to cause a computer to execute operations, the operations comprising:
outputting a notification that video is available for display, the video being obtained by imaging, with a camera, a sidewalk along which a pedestrian passes, the sidewalk bordering on a roadway on which an automated driving vehicle travels; and
displaying the video in response to an operation, by an operator of the automated driving vehicle, to instruct display of the video.

12. The non-transitory computer readable medium according to claim 11, wherein the displaying includes:
transmitting a request to a driving assistance apparatus upon accepting the operation;
receiving the video from the driving assistance apparatus; and
displaying the received video.

13. The non-transitory computer readable medium according to claim 11, wherein
the operations further comprise receiving the video from the driving assistance apparatus, and
the displaying includes starting to display the received video upon accepting the operation.

14. The non-transitory computer readable medium according to claim 11, wherein the notification includes a graphic element to accept the operation.

15. The non-transitory computer readable medium according to claim 14, wherein the operation is a tap on the graphic element.

16. The non-transitory computer readable medium according to claim 14, wherein the graphic element is a button.

17. The non-transitory computer readable medium according to claim 14, wherein the graphic element is an icon indicating the pedestrian.

18. A driving assistance method comprising:
acquiring, by a driving assistance apparatus, video obtained by imaging, with a camera, a sidewalk along which a pedestrian passes, the sidewalk bordering on a roadway on which an automated driving vehicle travels; and
upon detecting the pedestrian in the acquired video, causing, by the driving assistance apparatus, a terminal apparatus of an operator of the automated driving vehicle to output a notification that the video is available for display.

19. The driving assistance method according to claim 18, wherein
the terminal apparatus is configured to transmit a request to the driving assistance apparatus upon accepting an operation by the operator to instruct display of the video, and
the driving assistance method further comprises transmitting, by the driving assistance apparatus, the video to the terminal apparatus in response to the request.

20. The driving assistance method according to claim 18, wherein
the terminal apparatus is configured to start displaying the video upon accepting an operation by the operator to instruct display of the video, and
the driving assistance method further comprises continuing, by the driving assistance apparatus, transmitting the video to the terminal apparatus, regardless of presence or absence of a request from the terminal apparatus.
